(19) United States
(12) Patent Application Publication
(10) Pub. No.: US 2018/0234918 A1
(43) Pub. Date: Aug. 16, 2018

(54) WAKEUP RADIO SYNCHRONIZATION TECHNIQUES

(71) Applicant: QUALCOMM Incorporated, San Diego, CA (US)

(72) Inventors: Alfred Asterjadhi, San Diego, CA (US); Yanjun Sun, San Diego, CA (US); George Cherian, San Diego, CA (US)

(21) Appl. No.: 15/896,006

(22) Filed: Feb. 13, 2018

Related U.S. Application Data
(60) Provisional application No. 62/459,030, filed on Feb. 14, 2017.

(51) Int. Cl. H04W 52/02; H04W 72/04; H04W 56/00

(52) U.S. Cl. CPC H04W 52/0216; H04W 72/0446; H04W 56/001; H04W 72/042

(57) ABSTRACT

Methods, systems, and devices for wireless communication are described. An access point (AP) may establish a wakeup radio listen schedule for a station (STA) such that a wakeup radio of the STA is powered on to listen for wakeup messages according to wakeup signals transmitted by the AP (e.g., to power on a primary radio). The AP may identify synchronization information such as clock, interval, and offset information for the wakeup radio listen schedule, and may transmit the synchronization information to the STA, such that the STA may synchronize the wakeup radio for wakeup messages. In some cases, the STA may monitor for the synchronization information using a primary radio (e.g., from periodic beacon signals sent by the AP). In other cases, the STA may receive synchronization information in a wakeup signal (e.g., using the wakeup radio). In some examples, the STA may indicate a preferred synchronization mechanism in advance.

### CROSS REFERENCES

The present Application for Patent claims priority to U.S. Provisional Patent Application No. 62/459,030 by Asterjadhi, et al., entitled “Wakeup Radio Synchronization Techniques,” filed Feb. 14, 2017, assigned to the assignee hereof, and expressly incorporated by reference herein.

### BACKGROUND

The present disclosure relates generally to wireless communication, and more specifically to wakeup radio synchronization techniques.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink and uplink. The downlink (or forward link) may refer to the communication link from the AP to the station, and the uplink (or reverse link) may refer to the communication link from the station to the AP.

A wireless device may have a limited amount of battery power. In some cases, it may be beneficial for a primary radio (e.g., of a wireless device) to remain in a sleep mode or low power mode for extended periods of time. During a sleep mode, a wireless device may periodically activate a radio, such as a wakeup radio (which may also be referred to as a wakeup receiver (WUR) radio), to listen for and decode a wakeup signal from an AP. In some examples, the wakeup signal may be a signal of reduced code rate and/or bandwidth (e.g., a narrowband signal), and may be used to indicate whether communications are waiting at the AP to be transmitted to the wireless device. The wireless device may then power on a primary radio of the wireless device in response to receiving the wakeup signal. In some cases, the wireless device may cycle the wakeup radio (e.g., power the wakeup radio off to save power and turn the wakeup radio on to receive wakeup messages). However, the wireless device may be unaware of when to activate the wakeup radio so that the wakeup radio is active during transmission of a wakeup signal from the AP. Improved techniques for wakeup radio synchronization may thus be desired.

### SUMMARY

The described techniques relate to improved methods, systems, devices, or apparatuses that support wakeup radio synchronization techniques. Generally, the described techniques provide for a station (STA) to listen for wakeup messages received in a wakeup signal (e.g., via a wakeup radio) from an access point (AP) according to a wakeup radio listen schedule. The wakeup radio listen schedule may define time periods during which a wakeup radio of a STA is powered on to listen for wakeup messages from an AP, and time periods during which the wakeup radio may be powered off in an off or sleep state. The AP may transmit clock, interval, and offset information to one or more STAs, and a STA receiving the clock, interval, and offset information may synchronize the wakeup radio listen schedule based at least in part on the received clock, interval, and offset information. The receiving STA may then listen for subsequent wakeup messages, using the wakeup radio, according to the synchronized wakeup radio listen schedule. In some cases, the clock, interval, and offset information for the wakeup radio may be received using the primary radio of the STA as part of a beacon signal or in a message dedicated to the transmission of clock information, such a beacon-like message including this timing information, but not other information generally carried by a beacon. In other cases, the clock, interval, and offset information for the wakeup radio may be received using the wakeup radio of the STA as part of a wakeup signal including this timing information. A method of wireless communication at a first wireless device is described.

The method may include listening, using a wakeup radio of the first wireless device, for one or more wakeup messages according to a wakeup radio listen schedule, the wakeup radio listen schedule defining time periods during which the wakeup radio of the first wireless device is powered on to listen for wakeup messages, receiving, from a second wireless device, clock, interval, and offset information for the wakeup radio listen schedule, synchronizing the wakeup radio listen schedule based at least in part on the received clock, interval, and offset information, and listening, using the wakeup radio, for one or more wakeup messages based at least in part on the synchronized wakeup radio listen schedule.

Some examples of the method described above may further include processes, features, means, or instructions for monitoring for the clock, interval, and offset information using a primary radio of the first wireless device.

In some examples of the method described above, receiving the clock, interval, and offset information further comprises receiving, from the second wireless device using the primary radio, the clock information associated with the wakeup radio listen schedule in one or more beacon signals or one or more messages dedicated to the transmission of clock information.

In some examples of the method described above, receiving the clock, interval, and offset information further comprises receiving, from the second wireless device and using the wakeup radio of the first wireless device, at least a first one of the clock information, the interval information, and the offset information. Some examples of the method described above may further include processes, features, means, or instructions for receiving, from the second wireless device and using the primary radio of the first wireless device, at least a second one of the clock information, the interval information, and the offset information.

In some examples of the method described above, receiving the clock, interval, and offset information further comprises receiving a wakeup signal using the wakeup radio of the first wireless device, the wakeup signal including the clock information, or the interval information, or the offset information, or a combination thereof.

Some examples of the method described above may further include processes, features, means, or instructions for activating a primary radio of the first wireless device based at least in part on the received wakeup signal. Some examples of the method described above may further include processes, features, means, or instructions for communicating with the second wireless device using the primary radio.

In some examples of the method described above, receiving the clock, interval, and offset information further comprises receiving the clock information in a first message from the second wireless device. Some examples of the method described above may further include processes, features, means, or instructions for receiving the interval information, or the offset information, or a combination thereof, in a second message from the second wireless device.

Some examples of the method described above may further include processes, features, means, or instructions for transmitting, to the second wireless device, an indication of a synchronization mechanism preference for the first wireless device.

In some examples of the method described above, the synchronization mechanism preference includes a preference for receiving, using the wakeup radio of the first wireless device, the clock information, or the interval information, or the offset information, or a combination thereof.

In some examples of the method described above, the first wireless device may be a wireless communication terminal and further comprises an antenna and a transceiver.

In some examples of the method described above, the clock information includes at least a portion of timing synchronization function (TSF) information.

In some examples of the method described above, the portion of TSF information comprises one or more least significant bits (LSBs) of the TSF information for the second wireless device.

A method of wireless communication at a first wireless device is described. The method may include establishing a wakeup radio listen schedule for a second wireless device associated with the first wireless device, the wakeup radio listen schedule defining time periods during which a wakeup radio of the second wireless device is powered on to listen for wakeup messages, transmitting one or more wakeup signals to the second wireless device based at least in part on the wakeup radio listen schedule, identifying clock, interval, and offset information for the wakeup radio listen schedule, and transmitting the identified clock, interval, and offset information to the second wireless device to synchronize the wakeup radio listen schedule at the second wireless device.

Some examples of the method described above may further include processes, features, means, or instructions for receiving, from the second wireless device, an indication of a synchronization mechanism preference for the second wireless device, wherein the identified clock, interval, and offset information may be transmitted to the second wireless device based at least in part on the received indication of the synchronization mechanism preference for the second wireless device.

In some examples of the method described above, the indication of the synchronization mechanism preference for the second wireless device comprises transmitting the identified clock, interval, and offset information to the wakeup radio of the second wireless device based at least in part on the received synchronization mechanism preference.

In some examples of the method described above, transmitting the identified clock, interval, and offset information further comprises transmitting the identified interval and offset information to a primary radio of the second wireless device.

In some examples of the method described above, transmitting the identified clock, interval, and offset information further comprises transmitting, to the wakeup radio of the second wireless device, at least a first one of the clock information, the interval information, and the offset information. Some examples of the method described above may further include processes, features, means, or instructions for transmitting, to the primary radio of the second wireless device, at least a second one of the clock information, the interval information, and the offset information.

In some examples of the method described above, transmitting the identified clock, interval, and offset information further comprises transmitting the clock information in a first message to the second wireless device. Some examples of the method described above may further include processes, features, means, or instructions for transmitting the interval information, or the offset information, or a combination thereof, in a second message to the second wireless device.

In some examples of the method described above, transmitting the identified clock, interval, and offset information further comprises transmitting the identified clock information to the wakeup radio of the second wireless device.

Some examples of the method described above may further include processes, features, means, or instructions for identifying a range of a wakeup radio of the first wireless device to transmit a wakeup message. Some examples of the method described above may further include processes, features, means, or instructions for selecting a parameter of a primary radio of the first wireless device used to transmit the identified clock, interval, and offset information based at least in part on the identified range, the parameter comprising a modulation and coding scheme (MCS), a physical layer convergence procedure (PLCP) protocol data unit (PPDU) format, bandwidth, or a combination thereof.

Some examples of the method described above may further include processes, features, means, or instructions for identifying a target wakeup time interval of the second wireless device. Some examples of the method described above may further include processes, features, means, or instructions for transmitting the identified clock, interval, and offset information during the identified target wakeup time interval.

In some examples of the method described above, the clock information includes at least a portion of TSF information.

In some examples of the method described above, the portion of TSF information comprises include one or more LSBs of the TSF information for the first wireless device.

### BRIEF DESCRIPTION OF THE DRAWINGS

FIG. 1 illustrates an example of a wireless communication system that supports wakeup radio synchronization techniques in accordance with aspects of the present disclosure.

FIG. 2 illustrates an example of a wireless communication system that supports wakeup radio synchronization techniques in accordance with aspects of the present disclosure.

FIGS. 3A and 3B illustrate examples of a transmission timeline that support wakeup radio synchronization techniques in accordance with aspects of the present disclosure.

FIG. 4 illustrates an example of a process flow that supports wakeup radio synchronization techniques in accordance with aspects of the present disclosure.

FIGS. 5 through 7 show block diagrams of a device that supports wakeup radio synchronization techniques in accordance with aspects of the present disclosure.

FIG. 8 illustrates a block diagram of a system including a station (STA) that supports wakeup radio synchronization techniques in accordance with aspects of the present disclosure.

FIGS. 9 through 11 show block diagrams of a device that supports wakeup radio synchronization techniques in accordance with aspects of the present disclosure.

FIG. 12 illustrates a block diagram of a system including an AP that supports wakeup radio synchronization techniques in accordance with aspects of the present disclosure.

FIGS. 13 through 17 illustrate methods for wakeup radio synchronization techniques in accordance with aspects of the present disclosure.

### DETAILED DESCRIPTION

In some wireless communication systems, wireless devices (e.g., stations (STAs)) may be configured to communicate with other wireless devices (e.g., an access point (AP)) using a primary radio and a companion radio, such as a wakeup radio (which may also be referred to herein as a wakeup receiver (WUR) radio). For example, an AP may send a wakeup signal to a wakeup radio of a STA, indicating that the AP has some data to transmit via the primary radio to the STA. A STA, using a wakeup radio, may periodically listen for such wakeup signals. The STA may receive the wakeup signal during a listening interval, and receive the wakeup signal. The STA may then provide the primary radio of the STA with an indication to wake up to receive the pending data from the AP.

A STA operating in such a low power state, periodically powering on and off its wakeup radio, may be unaware of a transmitted wakeup signal if the STA is not synchronized to wake during intervals when an AP may transmit a wakeup signal to the STA. As such, an AP may signal synchronization information to the STA. Synchronization information may allow the STA to align periodic wakeup radio listen periods (e.g., periodic wakeup radio activation) with the timing of future wakeup radio transmissions. APs may convey synchronization information such as timing synchronization function (TSF) information. TSF information may include a transmission time stamp, a listening interval or listening periodicity, an interval offset, etc. STAs may use such information to synchronize the wakeup radio listening periods with the AP. According to techniques described herein, a STA may receive synchronization information from an AP via the primary radio or the wakeup radio.

An AP may indicate what synchronization mechanism is currently being used. In some applications, wakeup radio listen intervals may be synchronized on the primary radio by default, unless a client (e.g., a STA) requests synchronization information through the wakeup radio (e.g., opportunistic wakeup radio synchronization). Synchronization via the primary radio may include the AP signaling wakeup radio synchronization information in periodic beacons or some other frame, and may be associated with reduced synchronization signaling overhead. Synchronization via the wakeup radio may include piggy-backing wakeup radio synchronization information in wakeup radio wakeup frames, and may be associated with reduced power consumption.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Aspects of the disclosure are initially described in the context of a wireless communication system. Examples timelines and process flows illustrating wakeup radio synchronization techniques are then described. Aspects of the disclosure are further illustrated by and described with reference to apparatus diagrams, system diagrams, and flowcharts that relate to wakeup radio synchronization techniques.

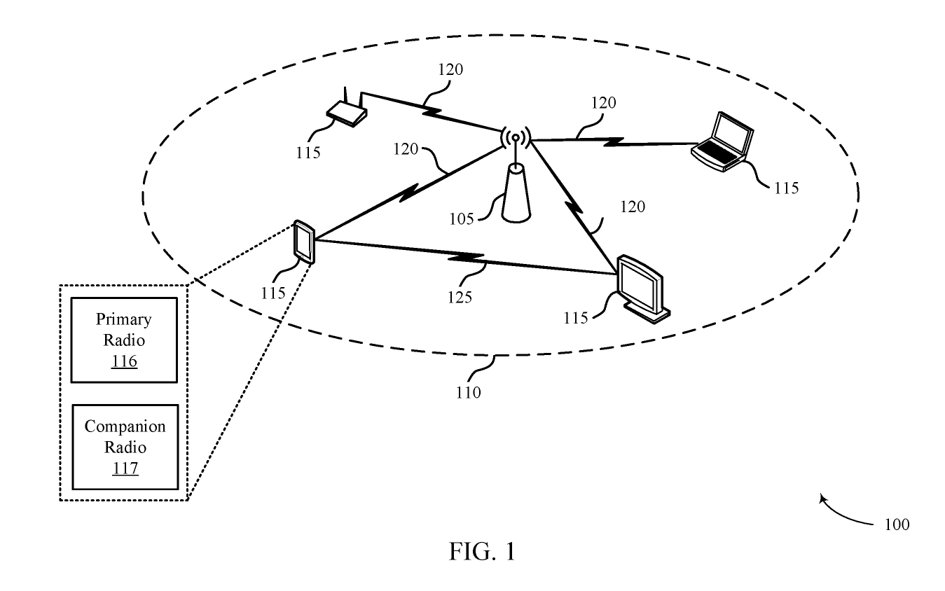

FIG. 1 illustrates a wireless local area network (WLAN) 100 (also known as a Wi-Fi network) configured in accordance with various aspects of the present disclosure. The WLAN 100 may include an AP 105 and multiple associated STAs 115, which may represent devices such as wireless communication terminals, including mobile stations, phones personal digital assistant (PDAs), other handheld devices, netbooks, notebook computers, tablet computers, laptops, display devices (e.g., TVs, computer monitors, etc.), printers, etc. The AP 105 and the associated STAs 115 may represent a basic service set (BSS) or an extended service set (ESS). The various STAs 115 in the network can communicate with one another through the AP 105. Also shown is a coverage area 110 of the AP 105, which may represent a basic service area (BSA) of the WLAN 100. An extended network station associated with the WLAN 100 may be connected to a wired or wireless distribution system that may allow multiple APs 105 to be connected in an ESS. WLAN 100 may support media access control for wakeup radio.

A STA 115 may include a primary radio 116 and a low power companion radio 117 for communication. The primary radio 116 may be used during active modes (e.g., full power modes) or for high-data throughput applications. A low-power companion radio 117 may be used during low-power modes or for low-throughput applications. In some examples, the primary radio 116 may also be referred to as a primary connectivity radio or main radio, etc. In some examples, the low-power companion radio 117 may be a wakeup radio (e.g., a WUR radio), and may also be referred to as a low-power companion radio, low power wakeup radio, etc. In some examples, the companion radio 117 (e.g., a wakeup radio) may include a wakeup receiver and/or a wakeup transmitter. For example, when STA 115 or AP 105 may transmit a wakeup message, STA 115 may use a wakeup transmitter of its companion radio 117. When STA 115 may receive a wakeup message, STA 115 may use a wakeup receiver of its companion radio 117.

A STA 115 may listen using a wakeup radio, such as companion radio 117, for a wakeup message or wakeup frame in a wakeup waveform (e.g., a wakeup signal). In some cases, STA 115 may receive a preamble having a first bandwidth (e.g., wideband, such as on a 20 MHz channel) and a wakeup signal having a second bandwidth (e.g., narrowband, such as a 4-5 MHz channel within the 20 MHz channel). Further, the companion radio 117 may share the same medium (e.g., frequency spectrum targeted for reception) as primary radio 116. However, transmissions intended for companion radio 117 may be associated with lower data rates (e.g., tens or hundreds of kbps).

A STA 115 may be located in the intersection of more than one coverage area 110 and may associate with more than one AP 105. A single AP 105 and an associated set of STAs 115 may be referred to as a BSS. An ESS is a set of connected BSSs. A distribution system may be used to connect APs 105 in an ESS. In some cases, the coverage area 110 of an AP 105 may be divided into sectors. The WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, 802.11ba, etc. In other implementations, peer-to-peer connections or ad hoc networks may be implemented within WLAN 100. Devices in WLAN 100 may communicate over unlicensed spectrum, which may be a portion of spectrum that includes frequency bands traditionally used by Wi-Fi technology, such as the 5 GHz band, the 2.4 GHz band, the 60 GHz band, the 3.6 GHz band, and/or the 900 MHz band. The unlicensed spectrum may also include other frequency bands. Devices in WLAN 100 may additionally or alternatively communicate over shared licensed spectrum.

STAs 115 within each BSS may remain in synchronization with an AP 105 via periodic beacon frame transmissions from the AP 105. Beacon frames may ensure all STAs 115 operate with the same communication parameters, and may include information such as a beacon period parameter, a channel number, a frequency hopping sequence, TSF information, etc. For example, STAs 115 may each maintain a local timer (e.g., a TSF timer), and may receive TSF information such as a time stamp (e.g., to calibrate the local timer) from beacon frames sent by the AP 105. Therefore, TSF information may be used for clock synchronization between APs 105 and STAs 115.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (e.g., carrier sense multiple access with collision avoidance (CSMA/CA)) because the STAs 115 may not refrain from transmitting on top of each other. A STA 115 whose transmissions are not identifiable, but that is within the same coverage area 110 may be known as a hidden node. CSMA/CA may be supplemented by the exchange of a request to send (RTS) packet transmitted by a sending STA 115 (or AP 105) and a clear to send (CTS) packet transmitted by the receiving STA 115 (or AP 105). This may alert other devices within range of the sender and receiver not to transmit for the duration of the primary transmission. Thus, RTS/CTS may help mitigate a hidden node problem.

As discussed above, a STA 115 may periodically activate a radio, such as a wakeup radio, to listen for and decode, if received, wakeup signals from an AP 105. However, the STA 115 may be unaware of when to periodically activate a wakeup radio to ensure that the wakeup radio is active during potential wakeup transmissions from the AP 105. The following disclosure provides for synchronization techniques between the STA 115 and AP 105. Such techniques may provide for improved power efficiency and communication latency tradeoff for STAs 115 including a primary radio 116 and a companion radio 117.

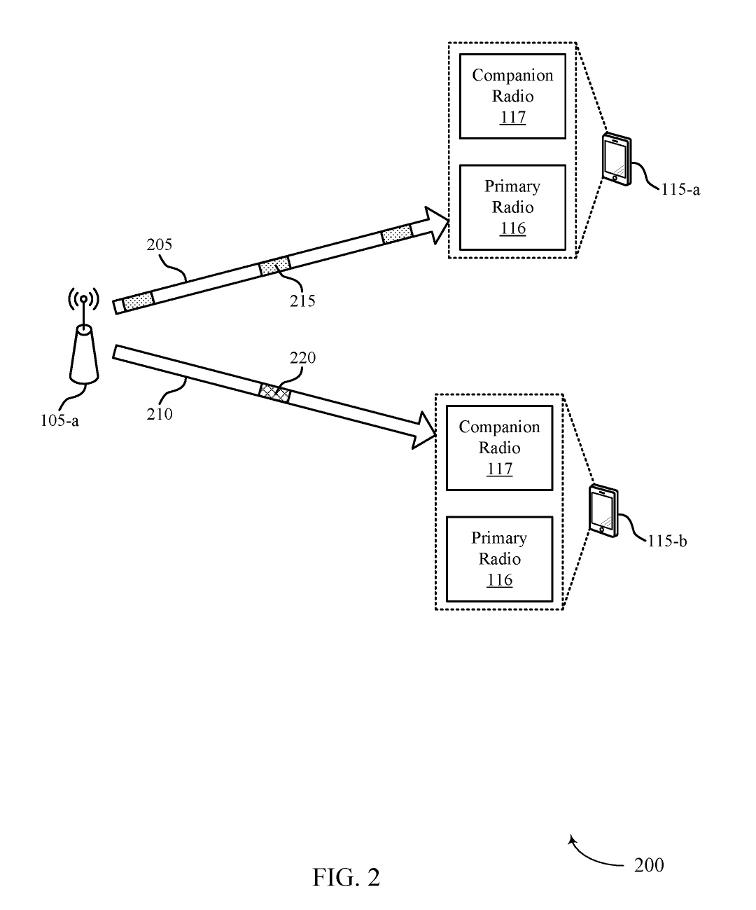

FIG. 2 illustrates an example of a wireless communications system 200 that supports wakeup radio synchronization techniques in accordance with various aspects of the present disclosure. Wireless communications system 200 may include an AP 105-a, a STA 115-a, and a STA 115-b, which may be examples of the corresponding devices described with reference to FIG. 1. STA 115-a and STA 115-b may include a primary radio 116 (e.g., a main radio) and a companion radio 117 (e.g., a wakeup radio) for communication. The primary radio 116 may be used during active modes or for high-data throughput applications (e.g., for full power transmissions 205 from AP 105-a). Full power transmissions 205 may include beacons 215. Beacons 215 may be transmitted periodically by an AP 105-a. The low-power companion radio 117 may be used during low-power modes or for low-throughput applications (e.g., for wakeup radio transmissions 210 from AP 105-a). Wakeup radio transmissions 210 may include wakeup signals 220. A STA 115 may receive a wakeup signal 220 and power additional circuitry (e.g., primary radio 116). In some examples, the low-power companion radio 117 may be a wakeup radio. The companion radio 117 may listen for wakeup signals from AP 105-a, and upon receiving a wakeup signal including a wakeup message for STA 115, wakeup the primary radio 116 of STA 115 for primary communications (e.g., full power, high-data throughput applications).

STAs 115 may operate in a low power mode, such that companion radios 117 are periodically activated to listen for and decode wakeup signals from an AP 105. Wireless communications system 200 illustrates synchronization techniques that enable efficient periodic activation of companion radios 117 by aligning wakeup radio transmissions 210 (e.g., wakeup signals 220) with periodic STA 115 wakeup radio listening periods according to a wakeup radio listen schedule. Listening periods may refer to time durations where a STA 115 activates or wakes up a companion radio 117 to monitor for wakeup signals 220.

In some cases, to achieve synchronization, APs 105 may convey information such as TSF information to STAs 115. TSF information may include a transmission time stamp (e.g., clock information), a listening interval or period (e.g., interval information), an interval offset (e.g., offset information), etc. In some cases, TSF information may include refer to partial TSF information of the AP (e.g., TSF information may be sent as one or more least significant bits (LSBs)). STAs 115 may use such information to synchronize the companion radio 117. According to techniques described herein, synchronization information may be received by the STA 115 via the primary radio 116 or the companion radio 117. In some cases, the companion radio 117 may assume a synchronized on/off duty cycle based on TSF of the primary radio 116 in order to save power. The AP 105 may indicate what synchronization mechanism is currently being used. In some applications, wakeup radio listen intervals may be synchronized on the primary radio 116 by default, unless a STA 115 requests synchronization information through the companion radio 117. For example, parts of TSF of the main radio may be sent for synchronization, and synchronization may be disabled through the wakeup radio if the client no longer needs the information (e.g., the STA 115 may default back to synchronization via primary radio 116).

In the present example, AP 105-a may transmit full power communications (e.g., full power transmissions 205) to be received by primary radio 116 of STA 115-a. STA 115-a may synchronize the companion radio 117 via synchronization information (e.g., TSF information) received in beacons 215 at the primary radio 116. Beacons 215 may be transmitted periodically by AP 105-a. In some cases, beacons 215 may represent mini-beacons, which may be sent separately from normal beacons, and may, for example, represent a shortened version with less management information than other beacons. The primary radio may periodically turn on to receive the beacons 215, but may reduce the amount of signaling overhead compared to conveying synchronization information in wakeup radio transmissions 210 which may be associated with lower data rates.

Additionally or alternatively, AP 105-a may transmit wakeup signals or wakeup radio transmissions 210 to be received by companion radio 117 of STA 115-b. STA 115-b may synchronize the companion radio 117 via synchronization information (e.g., TSF information) received in wakeup signals 220 (e.g., synchronization information in wakeup messages). For example, TSF information may be piggy-back in wakeup signals 220 (e.g., that are traffic driven) to reduce the frequency of beacons 215 (e.g., reduce power consumed by primary radio 116) and enable opportunistic companion radio 117 synchronization. Opportunistic companion radio 117 synchronization may refer to wakeup radio synchronization at the request of STA 115-b or wakeup radio synchronization when AP 105-a has pending data for STA 115-b (e.g., when STA 115-b is to receive a wakeup frame). For example, when the STA 115-b wants to operate in a low power or wakeup radio mode, the STA 115-b may request that the AP 105-a initiate the wakeup radio schedule and begin generation of wakeup signals 220 that include TSF information.

Whether synchronization is achieved through a primary radio 116 or a companion radio 117 may be case or scenario dependent. If a STA 115 wakes up often (e.g., such as every delivery traffic indication map (DTIM) period for a broadcast packet), synchronization via primary radio 116 may be more efficient as TSF information may be obtained with little to no additional overhead (e.g., airtime). That is, if STA 115-a will wakeup often, synchronization information may be conveyed through beacons 215 or in a dedicated short frame sent at predefined intervals. If STA 115-b generally receives very little traffic or is power limited, synchronization information may be conveyed through wakeup radio transmissions 210, as such signaling consumes less power to convey TSF information than signaling through full power transmissions 205 received by primary radio 116.

In the examples discussed above, AP 105-a indicates the current time (e.g., timestamp) and listen intervals via synchronization information (e.g., TSF information). In some cases, TSF or parts of TSF of the main radio are sent for synchronization. This information may be sent as one or more LSBs as the clock shift may only utilize for example, the last few bytes. In some cases, techniques described herein may apply to synchronization information conveyed in new frames (e.g., carrying synchronization information) by analogy. The coverage of such a new frame may be designed to match WUR range (e.g., the range of the wakeup radio) by adjusting the modulation coding scheme (MCS), Physical Layer Convergence Procedure (PLCP) protocol data unit (PPDU), bandwidth, etc. For example, STAs 115 may utilize a high MCS for synchronization information signaling to nearby STAs 115, while a reduced MCS may be used to obtain sufficient coverage to far away STAs 115. In some cases, the synchronization frame discussed above may be sent during, for example, a target wake time (TWT) window of 802.11.

Synchronization via the companion radio 117 may conserve additional power, while synchronization via the primary radio 116 may reduce extra airtime (e.g., signaling overhead). In some applications, the companion radio 117 may be synched periodically (e.g., every 1 second, 10 seconds, etc.). The STAs 115 may receive synchronization information and adjust a clock (e.g., a local TSF timer) such that listen periods of the companion radio 117 (e.g., the listening schedules for the STAs 115) are aligned with wakeup radio transmissions 210 (e.g., wakeup signals 220).

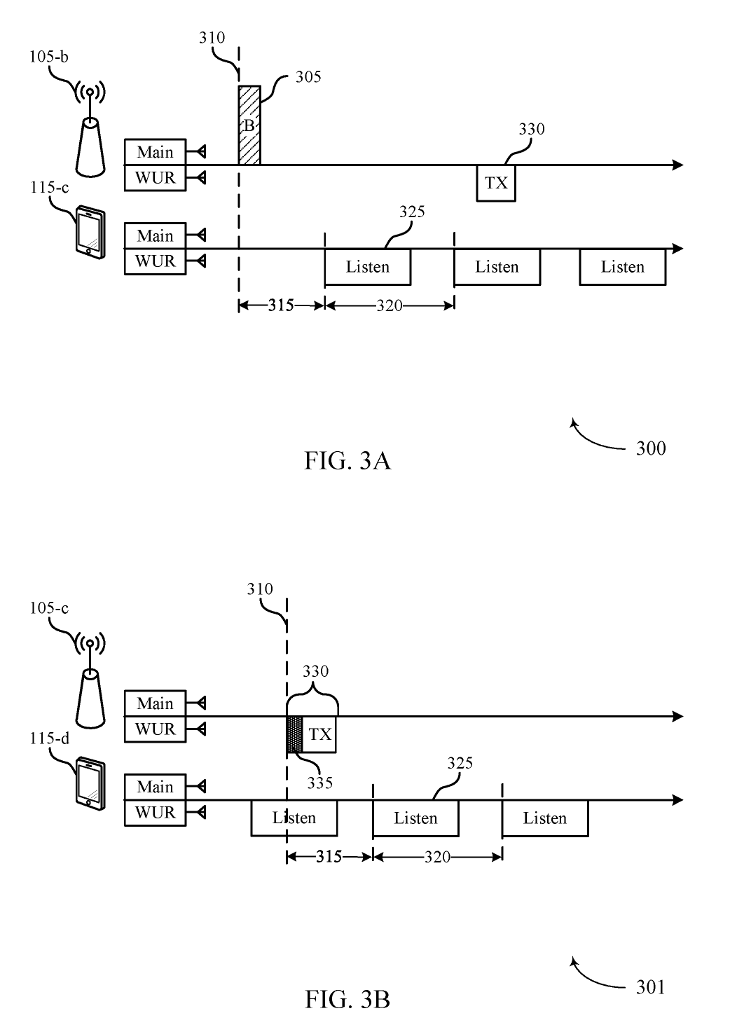

FIG. 3A illustrates an example of a transmission timeline 300 in accordance with one or more aspects of the present disclosure. Transmission timeline 300 illustrates communications between an AP 105-b and a STA 115-c, which may be examples of the corresponding devices described with reference to FIGS. 1-2. AP 105-b and a STA 115-c may include a main radio, which may be an example of a primary radio 116 and a wakeup radio, which may be an example of a companion radio 117 described with reference to FIGS. 1-2.

AP 105-b may transmit a beacon 305 using a primary radio 116. In the present example, the beacon 305 may include synchronization information such a timestamp 310, an interval offset 315, a listen interval 320 (e.g., TSF information), etc. Beacons 305 may include various additional information such as basic service set identification (BSSIDs), frame check sequences (FCSs), authentication information, and various other fields (e.g., according to some IEEE specification). The timestamp 310 may indicate a time at which the beacon 305 was transmitted according to a clock from the AP 105-b. In some cases, the interval offset 315 may indicate a time duration between a time indicated by the timestamp 310 and the beginning or start of a listen interval 320. The listen interval 320 may indicate a time between subsequent listen periods 325. In some cases, listen interval 320 may indicate the periodicity between periodic listen periods 325.

According to techniques described herein, transmission timeline 300 may illustrate synchronization via a main radio (e.g., a primary radio 116) of AP 105-b and STA 115-c. STA 115-c may receive the beacon 305 via a main radio, and use the synchronization information (e.g., TSF information) within the beacon 305 to synchronize the wakeup radio such that the listen periods of STA 115-c wakeup radio (e.g., companion radio 117) are synchronized with transmissions 330 (e.g., wakeup frames) sent by AP 105-b. That is, the timestamp 310, interval offset 315, and listen interval 320 indicated by beacon 305 may be used to by STA 115-c to determine when to activate the wakeup radio such that synchronization is achieved. Therefore, AP 105-b may signal transmissions 330 (e.g., wakeup frames) over a wakeup radio according to synchronization information sent in the beacon 305 during listen periods 325 of STA 115-c.

In some cases, the timings of wakeup radio listen intervals 320 may be based on TSF information exchanged through the primary radio 116 as described herein to reduce the amount of synchronization signaling airtime or overhead. As primary radio 116 communications may be associated with higher data rates, reduced overhead when signaling synchronization information may be achieved.

FIG. 3B illustrates an example of a transmission timeline 301 in accordance with one or more aspects of the present disclosure. Transmission timeline 301 illustrates communications between an AP 105-c and a STA 115-d, which may be examples of the corresponding devices described with reference to FIGS. 1-2. AP 105-c and a STA 115-d may include a main radio, which may be an example of a primary radio 116 and a wakeup radio, which may be an example of a companion radio 117 described with reference to FIGS. 1-2.

In contrast to the example of FIG. 3A, FIG. 3B illustrates the example where AP 105-c may transmit synchronization information using a wakeup radio (e.g., companion radio 117). For example, AP 105-c may piggy-back synchronization information 335 in transmission 330 (e.g., a wakeup signal or wakeup radio wakeup frame). Synchronization information 335 may include a timestamp 310, an interval offset 315, a listen interval 320 for use in synchronizing listen periods 325 of STA 115-d with wakeup frames (e.g., transmissions 330). In some cases, synchronization information may be referred to as TSF information. The timestamp 310 may indicate a time at which the beacon 305 was transmitted according to a clock from the AP 105-b. In some cases, the interval offset 315 may indicate a time duration between a time indicated by the timestamp 310 and the beginning or start of a listen interval 320. The listen interval 320 may indicate a time between subsequent listen periods 325. In some cases, listen interval 320 may indicate the periodicity between periodic listen periods 325.

According to techniques described herein, transmission timeline 301 may illustrate synchronization via a wakeup radio (e.g., a companion radio 117) of AP 105-c and STA 115-d. STA 115-d may receive a WUR wakeup frame (e.g., transmission 330) via a wakeup radio, and use the synchronization information (e.g., TSF information) within the WUR wakeup frame to synchronize the wakeup radio such that the listen periods of STA 115-d wakeup radio (e.g., companion radio 117) are synchronized with transmissions 330 (e.g., wakeup frames) sent by AP 105-c. That is, the timestamp 310, interval offset 315, and listen interval 320 indicated by transmission 330 may be used to by STA 115-d to determine when to activate the wakeup radio such that synchronization is achieved. Therefore, AP 105-c may signal transmissions 330 (e.g., wakeup frames) over a wakeup radio according to synchronization information sent in the transmission 330 during listen periods 325 of STA 115-d.

In some cases, the timings of wakeup radio listen intervals 320 may be based on TSF information exchanged through the companion radio 117 as described herein to reduce power consumption. As companion radio 117 communications may be associated with low power operation, reduced power consumption when signaling and receiving synchronization information may be achieved.

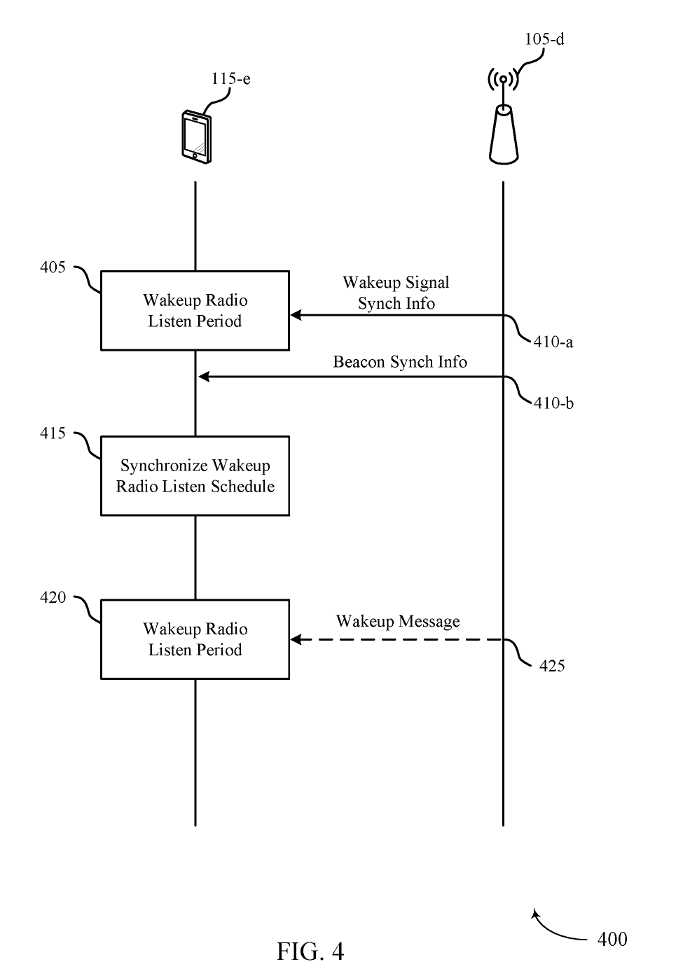

FIG. 4 illustrates an example of a process flow 400 for improved wakeup radio synchronization techniques in accordance with one or more aspects of the present disclosure. Process flow 400 may include AP 105-d and STA 115-e, which may represent aspects of techniques performed by a STA 115 or AP 105 as described with reference to FIGS. 1-3. In some cases AP 105-d may be another wireless device, such as another STA 115. Similarly, in some cases STA 115-e may be another wireless device, such as an AP 105.

At 405, STA 115-e may listen for wakeup message using a wakeup radio (e.g., a companion radio 117). The listen periods during which STA 115-e listens for wakeup messages may be based on a wakeup radio listen schedule that defines time periods during which the wakeup radio of STA 115-e is powered on to listen for wakeup messages.

At 410-a, AP 105-d may transmit a message including synchronization information such as a clock, interval, and offset relating to a wakeup radio listen schedule. In some cases, the message may be received by STA 115-e during the wakeup radio listen period. For example, the clock, interval, and offset information may be received in a wakeup signal sent from AP 105-d. In some cases, STA 115-e may activate a primary radio based on the received wakeup signal. In such cases, STA 115-e may then communicate with AP 105-d using the primary radio. In some cases, AP 105-d may identify a range of a wakeup radio, and select a parameter of a primary radio to transmit the identified clock, interval, and offset information based at least in part on the identified range. For example, the parameter may include a MCS, a PPDU format, bandwidth, etc.

In other cases, at step 410-b, STA 115-e may monitor for the clock, interval, and offset information using a primary radio (e.g., primary radio 116), in which case the synchronization information may not necessarily be received during the wakeup radio listen period. In such cases, the clock, interval, and offset information associated with the wakeup radio listen schedule may be received in one or more beacon signals from AP 105-d.

Alternatively, one or more messages dedicated to the transmission of clock information may be sent in lieu of beacon signals. In some cases, the primary radio may wake up during multiple DTIM intervals to monitor for the clock, interval, and offset information.

In some examples, STA 115-e may transmit an indication of a synchronization mechanism preference to AP 105-d. In some cases, the AP 105-d may identify a target wakeup time interval of the STA 115-e and transmit the identified clock, interval, and offset information during the identified target wakeup time interval.

At 415, STA 115-e may synchronize the wakeup radio listen schedule based on the information received at step 410 (e.g., wakeup radio listen schedule clock, interval, and offset information).

At 420, STA 115-e may listen for wakeup messages based on the synchronized wakeup radio listen schedule.

In some cases, at 425, STA 115-e may receive a wakeup message from AP 105-d during the synchronized wakeup listen period.

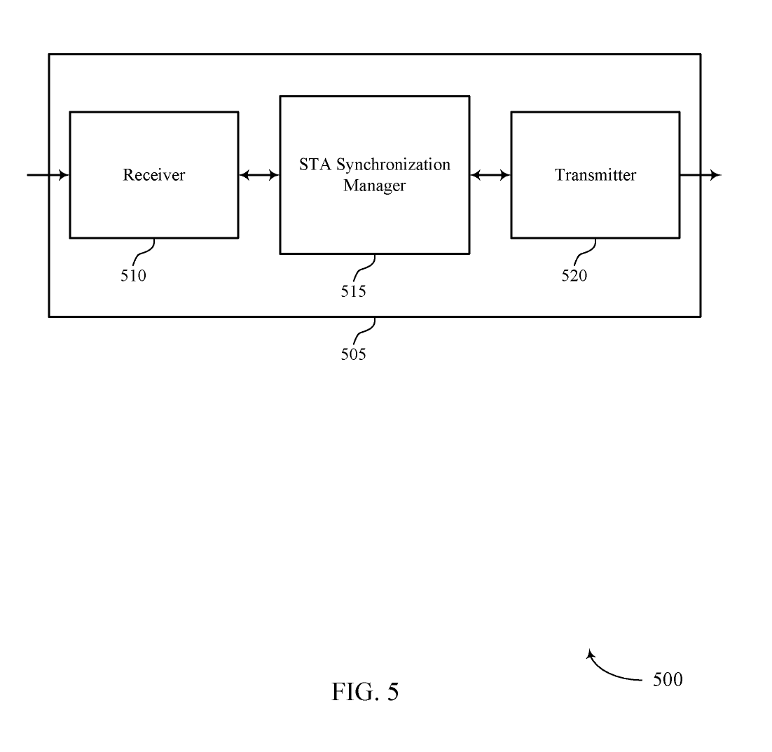

FIG. 5 shows a block diagram 500 of a wireless device 505 that supports wakeup radio synchronization techniques in accordance with various aspects of the present disclosure. Wireless device 505 may be an example of aspects of a STA 115 as described with reference to FIG. 1. Wireless device 505 may include receiver 510, STA synchronization manager 515, and transmitter 520. Wireless device 505 may also include a processor. Each of these components may be in communication with one another (e.g., via one or more buses).

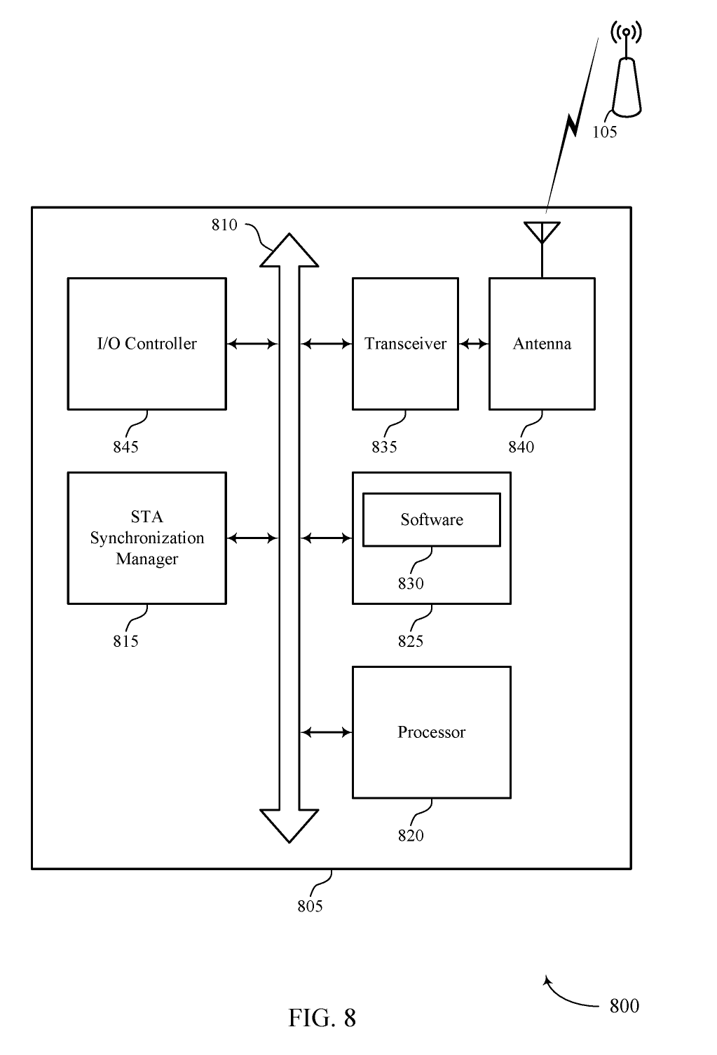

Receiver 510 may receive information such as packets, user data, or control information associated with various information channels (e.g., control channels, data channels, and information related to wakeup radio synchronization techniques, etc.). Information may be passed on to other components of the device. The receiver 510 may be an example of aspects of the transceiver 835 described with reference to FIG. 8.

STA synchronization manager 515 may be an example of aspects of the STA synchronization manager 815 described with reference to FIG. 8. STA synchronization manager 515 and/or at least some of its various sub-components may be implemented in hardware, software executed by a processor, firmware, or any combination thereof. If implemented in software executed by a processor, the functions of the STA synchronization manager 515 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The STA synchronization manager 515 and/or at least some of its various sub-components may be physically located at various positions, including being distributed such that portions of functions are implemented at different physical locations by one or more physical devices. In some examples, STA synchronization manager 515 and/or at least some of its various sub-components may be a separate and distinct component in accordance with various aspects of the present disclosure. In other examples, STA synchronization manager 515 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

STA synchronization manager 515 may listen, using a wakeup radio of the first wireless device, for one or more wakeup messages according to a wakeup radio listen schedule, the wakeup radio listen schedule defining time periods during which the wakeup radio of the first wireless device is powered on to listen for wakeup messages. STA synchronization manager 515 may receive, from a second wireless device (e.g., an AP), clock, interval, and offset information for the wakeup radio listen schedule, and synchronize the wakeup radio listen schedule based on the received clock, interval, and offset information. STA synchronization manager 515 may listen, using the wakeup radio, for one or more wakeup messages based on the synchronized wakeup radio listen schedule.

Transmitter 520 may transmit signals generated by other components of the device. In some examples, the transmitter 520 may be collocated with a receiver 510 in a transceiver module. For example, the transmitter 520 may be an example of aspects of the transceiver 835 described with reference to FIG. 8. The transmitter 520 may include a single antenna, or it may include a set of antennas.

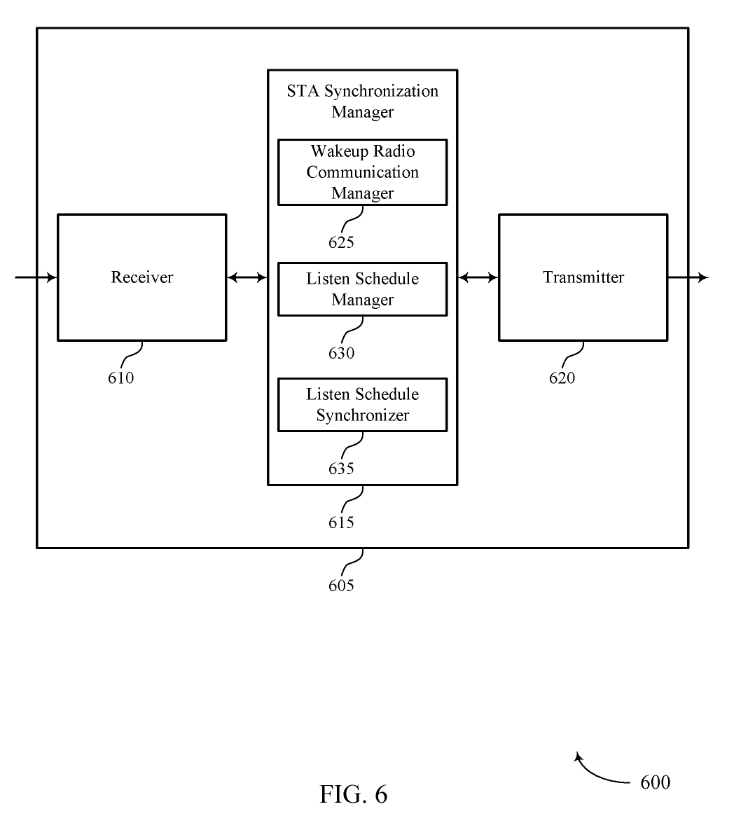

FIG. 6 shows a block diagram 600 of a wireless device 605 that supports wakeup radio synchronization techniques in accordance with various aspects of the present disclosure. Wireless device 605 may be an example of aspects of a wireless device 505 or a STA 115 as described with reference to FIGS. 1 and 5. Wireless device 605 may include receiver 610, STA synchronization manager 615, and transmitter 620. wireless device 605 may also include a processor. Each of these components may be in communication with one another (e.g., via one or more buses).

Receiver 610 may receive information such as packets, user data, or control information associated with various information channels (e.g., control channels, data channels, and information related to wakeup radio synchronization techniques, etc.). Information may be passed on to other components of the device. The receiver 610 may be an example of aspects of the transceiver 835 described with reference to FIG. 8.

STA synchronization manager 615 may be an example of aspects of the STA synchronization manager 815 described with reference to FIG. 8. STA synchronization manager 615 may also include wakeup radio communication manager 625, listen schedule manager 630, and listen schedule synchronizer 635.

Wakeup radio communication manager 625 may listen, using a wakeup radio of the first wireless device, for one or more wakeup messages according to a wakeup radio listen schedule, the wakeup radio listen schedule defining time periods during which the wakeup radio of the first wireless device is powered on to listen for wakeup messages. Wakeup radio communication manager 625 may listen, using the wakeup radio, for one or more wakeup messages based on the synchronized wakeup radio listen schedule, and activate a primary radio of the first wireless device based on the received wakeup signal.

Listen schedule manager 630 may receive, from a second wireless device, clock, interval, and offset information for the wakeup radio listen schedule. In some cases, receiving the clock, interval, and offset information includes receiving a wakeup signal using the wakeup radio of the first wireless device, the wakeup signal including one or more of the clock information, the interval information, and the offset information. Listen schedule manager 630 may receive from the second wireless device and using the wakeup radio of the first wireless device, at least a first one of the clock information, the interval information, and the offset information and receive, from the second wireless device and using the primary radio of the first wireless device, at least a second one of the clock information, the interval information, and the offset information. Listen schedule manager 630 may receive the clock information in a first message from the second wireless device and receive the interval information, or the offset information, or a combination thereof, in a second message from the second wireless device. In some cases, the clock information includes at least a portion (e.g., one or more LSBs) of TSF information for the second wireless device.

Listen schedule synchronizer 635 may synchronize the wakeup radio listen schedule based on the received clock, interval, and offset information.

Transmitter 620 may transmit signals generated by other components of the device. In some examples, the transmitter 620 may be collocated with a receiver 610 in a transceiver module. For example, the transmitter 620 may be an example of aspects of the transceiver 835 described with reference to FIG. 8. The transmitter 620 may include a single antenna, or it may include a set of antennas.

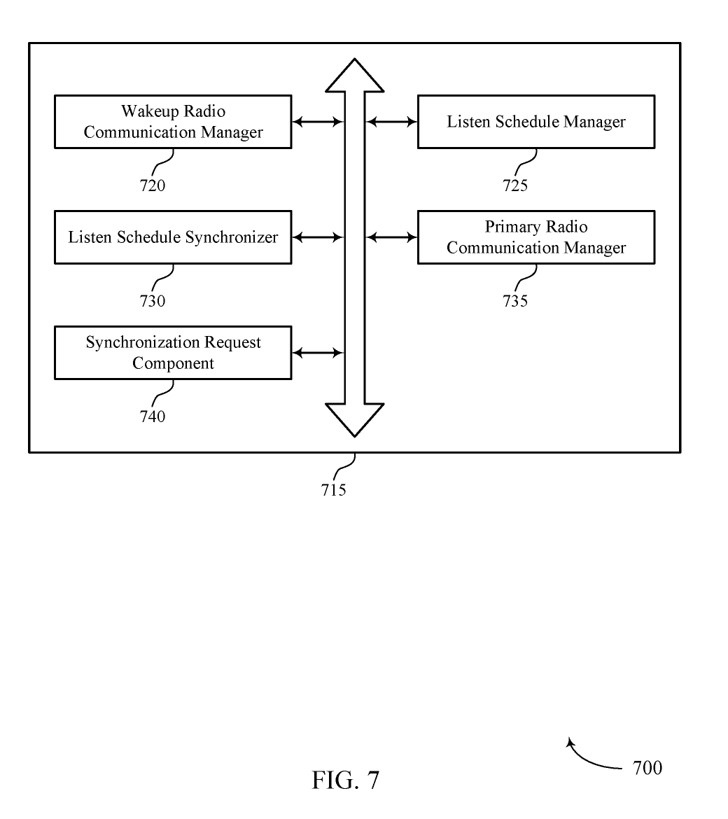

FIG. 7 shows a block diagram 700 of a STA synchronization manager 715 that supports wakeup radio synchronization techniques in accordance with various aspects of the present disclosure. The STA synchronization manager 715 may be an example of aspects of a STA synchronization manager 515, a STA synchronization manager 615, or a STA synchronization manager 815 described with reference to FIGS. 5, 6, and 8. The STA synchronization manager 715 may include wakeup radio communication manager 720, listen schedule manager 725, listen schedule synchronizer 730, primary radio communication manager 735, and synchronization request component 740. Each of these modules may communicate, directly or indirectly, with one another (e.g., via one or more buses).

Wakeup radio communication manager 720 may listen, using a wakeup radio of the first wireless device, for one or more wakeup messages according to a wakeup radio listen schedule, the wakeup radio listen schedule defining time periods during which the wakeup radio of the first wireless device is powered on to listen for wakeup messages. Wakeup radio communication manager 720 may listen, using the wakeup radio, for one or more wakeup messages based on the synchronized wakeup radio listen schedule, and activate a primary radio of the first wireless device based on the received wakeup signal.

Listen schedule manager 725 may receive, from a second wireless device, clock, interval, and offset information for the wakeup radio listen schedule. In some cases, receiving the clock, interval, and offset information includes receiving a wakeup signal using the wakeup radio of the first wireless device, the wakeup signal including one or more of the clock information, the interval information, and the offset information. Listen schedule manager 725 may receive from the second wireless device and using the wakeup radio of the first wireless device, at least a first one of the clock information, the interval information, and the offset information and receive, from the second wireless device and using the primary radio of the first wireless device, at least a second one of the clock information, the interval information, and the offset information. Listen schedule manager 725 may receive the clock information in a first message from the second wireless device and receive the interval information, or the offset information, or a combination thereof, in a second message from the second wireless device. In some cases, the clock information includes at least a portion (e.g., one or more LSBs) of TSF information for the second wireless device.

Listen schedule synchronizer 730 may synchronize the wakeup radio listen schedule based on the received clock, interval, and offset information.

Primary radio communication manager 735 may monitor for the clock, interval, and offset information using a primary radio of the first wireless device and communicate with the second wireless device using the primary radio. In some cases, receiving the clock, interval, and offset information includes receiving, from the second wireless device (e.g., the access point) using the primary radio, the clock information associated with the wakeup radio listen schedule in one or more beacon signals or one or more messages dedicated to the transmission of clock information. In some cases, the clock information includes at least a portion (e.g., one or more LSBs) of TSF information for the second wireless device.

Synchronization request component 740 may transmit, to the second wireless device, an indication of a synchronization mechanism preference for the first wireless device. In some cases, the synchronization mechanism preference includes a preference for receiving, using the wakeup radio of the first wireless device, the clock information, or the interval information, or the offset information, or a combination thereof.

FIG. 8 shows a diagram of a system 800 including a device 805 that supports wakeup radio synchronization techniques in accordance with various aspects of the present disclosure. Device 805 may be an example of or include the components of wireless device 505, wireless device 605, or a STA 115 as described above, e.g., with reference to FIGS. 1, 5 and 6. Device 805 may include components for bi-directional voice and data communications including components for transmitting and receiving communications, including STA synchronization manager 815, processor 820, memory 825, software 830, transceiver 835, antenna 840, and I/O controller 845. These components may be in electronic communication via one or more busses (e.g., bus 810).

Processor 820 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 820 may be configured to operate a memory array using a memory controller. In other cases, a memory controller may be integrated into processor 820. Processor 820 may be configured to execute computer-readable instructions stored in a memory to perform various functions (e.g., functions or tasks supporting wakeup radio synchronization techniques).

Memory 825 may include random access memory (RAM) and read only memory (ROM). The memory 825 may store computer-readable, computer-executable software 830 including instructions that, when executed, cause the processor to perform various functions described herein. In some cases, the memory 825 may contain, among other things, a basic input/output system (BIOS) which may control basic hardware and/or software operation such as the interaction with peripheral components or devices.

Software 830 may include code to implement aspects of the present disclosure, including code to support wakeup radio synchronization techniques. Software 830 may be stored in a non-transitory computer-readable medium such as system memory or other memory. In some cases, the software 830 may not be directly executable by the processor but may cause a computer (e.g., when compiled and executed) to perform functions described herein.

Transceiver 835 may communicate bi-directionally, via one or more antennas, wired, or wireless links as described above. For example, the transceiver 835 may represent a wireless transceiver and may communicate bi-directionally with another wireless transceiver. The transceiver 835 may also include a modem to modulate the packets and provide the modulated packets to the antennas for transmission, and to demodulate packets received from the antennas.

In some cases, the wireless device may include a single antenna 840. However, in some cases the device may have more than one antenna 840, which may be capable of concurrently transmitting or receiving multiple wireless transmissions.

I/O controller 845 may manage input and output signals for device 805. I/O controller 845 may also manage peripherals not integrated into device 805. In some cases, I/O controller 845 may represent a physical connection or port to an external peripheral. In some cases, I/O controller 845 may utilize an operating system such as iOS®, ANDROID®, MS-DOS®, MS-WINDOWS®, OS/2®, UNIX®, LINUX®, or another known operating system. In other cases, I/O controller 845 may represent or interact with a modem, a keyboard, a mouse, a touchscreen, or a similar device. In some cases, I/O controller 845 may be implemented as part of a processor. In some cases, a user may interact with device 805 via I/O controller 845 or via hardware components controlled by I/O controller 845.

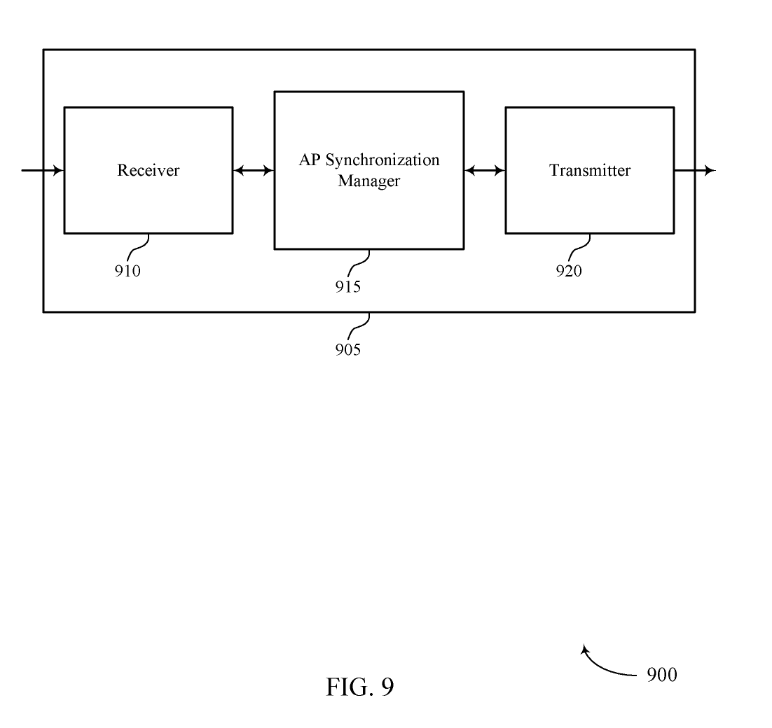

FIG. 9 shows a block diagram 900 of a wireless device 905 that supports wakeup radio synchronization techniques in accordance with various aspects of the present disclosure. Wireless device 905 may be an example of aspects of an AP 105 as described with reference to FIG. 1. wireless device 905 may include receiver 910, AP synchronization manager 915, and transmitter 920. Wireless device 905 may also include a processor. Each of these components may be in communication with one another (e.g., via one or more buses).

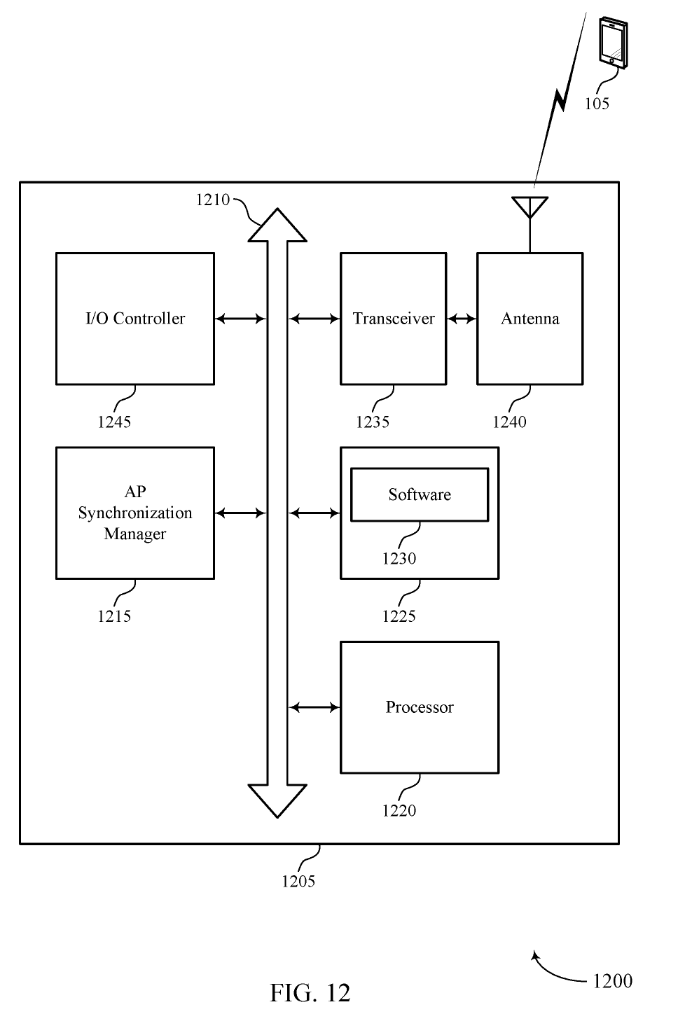

Receiver 910 may receive information such as packets, user data, or control information associated with various information channels (e.g., control channels, data channels, and information related to wakeup radio synchronization techniques, etc.). Information may be passed on to other components of the device. The receiver 910 may be an example of aspects of the transceiver 1235 described with reference to FIG. 12.

AP synchronization manager 915 may be an example of aspects of the AP synchronization manager 1215 described with reference to FIG. 12. AP synchronization manager 915 and/or at least some of its various sub-components may be implemented in hardware, software executed by a processor, firmware, or any combination thereof. If implemented in software executed by a processor, the functions of the AP synchronization manager 915 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure. The AP synchronization manager 915 and/or at least some of its various sub-components may be physically located at various positions, including being distributed such that portions of functions are implemented at different physical locations by one or more physical devices. In some examples, AP synchronization manager 915 and/or at least some of its various sub-components may be a separate and distinct component in accordance with various aspects of the present disclosure. In other examples, AP synchronization manager 915 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

AP synchronization manager 915 may establish a wakeup radio listen schedule for a first wireless device associated with the second wireless device, the wakeup radio listen schedule defining time periods during which a wakeup radio of the first wireless device is powered on to listen for wakeup messages. AP synchronization manager 915 may identify clock, interval, and offset information for the wakeup radio listen schedule, and transmit, to the first wireless device, the identified clock, interval, and offset information to the first wireless device to synchronize the wakeup radio listen schedule at the first wireless device.

Transmitter 920 may transmit signals generated by other components of the device. In some examples, the transmitter 920 may be collocated with a receiver 910 in a transceiver module. For example, the transmitter 920 may be an example of aspects of the transceiver 1235 described with reference to FIG. 12. The transmitter 920 may include a single antenna, or it may include a set of antennas. Transmitter 920 may transmit one or more wakeup signals to the first wireless device based on the wakeup radio listen schedule and transmit the identified clock, interval, and offset information during the identified target wakeup time interval.

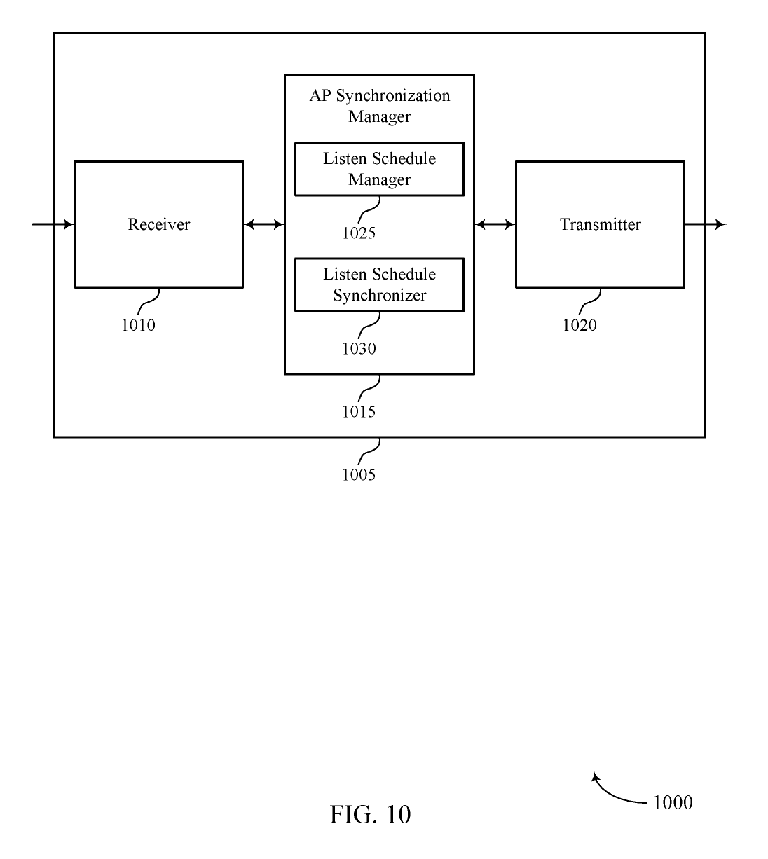

FIG. 10 shows a block diagram 1000 of a wireless device 1005 that supports wakeup radio synchronization techniques in accordance with various aspects of the present disclosure. Wireless device 1005 may be an example of aspects of a wireless device 905 or an AP 105 as described with reference to FIGS. 1 and 9. wireless device 1005 may include receiver 1010, AP synchronization manager 1015, and transmitter 1020. Wireless device 1005 may also include a processor. Each of these components may be in communication with one another (e.g., via one or more buses).

Receiver 1010 may receive information such as packets, user data, or control information associated with various information channels (e.g., control channels, data channels, and information related to wakeup radio synchronization techniques, etc.). Information may be passed on to other components of the device. The receiver 1010 may be an example of aspects of the transceiver 1235 described with reference to FIG. 12.

AP synchronization manager 1015 may be an example of aspects of the AP synchronization manager 1215 described with reference to FIG. 12. AP synchronization manager 1015 may also include listen schedule manager 1025 and listen schedule synchronizer 1030.

Listen schedule manager 1025 may establish a wakeup radio listen schedule for a first wireless device associated with the second wireless device, the wakeup radio listen schedule defining time periods during which a wakeup radio of the first wireless device is powered on to listen for wakeup messages, identify clock, interval, and offset information for the wakeup radio listen schedule, and identify a target wakeup time interval of the first wireless device.

Listen schedule synchronizer 1030 may transmit, to the first wireless device, the identified clock, interval, and offset information to the first wireless device to synchronize the wakeup radio listen schedule at the first wireless device. In some cases, transmitting the identified clock, interval, and offset information includes transmitting the identified interval and offset information to a primary radio of the first wireless device. In some cases, transmitting the identified clock, interval, and offset information further includes transmitting the identified clock information to a primary radio of the first wireless device in one or more beacon signals or one or more messages dedicated to the transmission of clock information. In some cases, transmitting the identified clock, interval, and offset information further includes transmitting the identified clock information to the wakeup radio of the first wireless device. In some cases, the clock information includes at least a portion (e.g., one or more LSBs) of TSF information for the second wireless device. In some cases, transmitting the identified clock, interval, and offset information includes transmitting, to the wakeup radio of the second wireless device, at least a first one of the clock information, the interval information, and the offset information and transmitting, to the primary radio of the second wireless device, at least a second one of the clock information, the interval information, and the offset information. In some cases, transmitting the identified clock, interval, and offset information includes transmitting the clock information in a first message to the second wireless device and transmitting the interval information, or the offset information, or a combination thereof, in a second message to the second wireless device.

Transmitter 1020 may transmit signals generated by other components of the device. In some examples, the transmitter 1020 may be collocated with a receiver 1010 in a transceiver module. For example, the transmitter 1020 may be an example of aspects of the transceiver 1235 described with reference to FIG. 12. The transmitter 1020 may include a single antenna, or it may include a set of antennas.

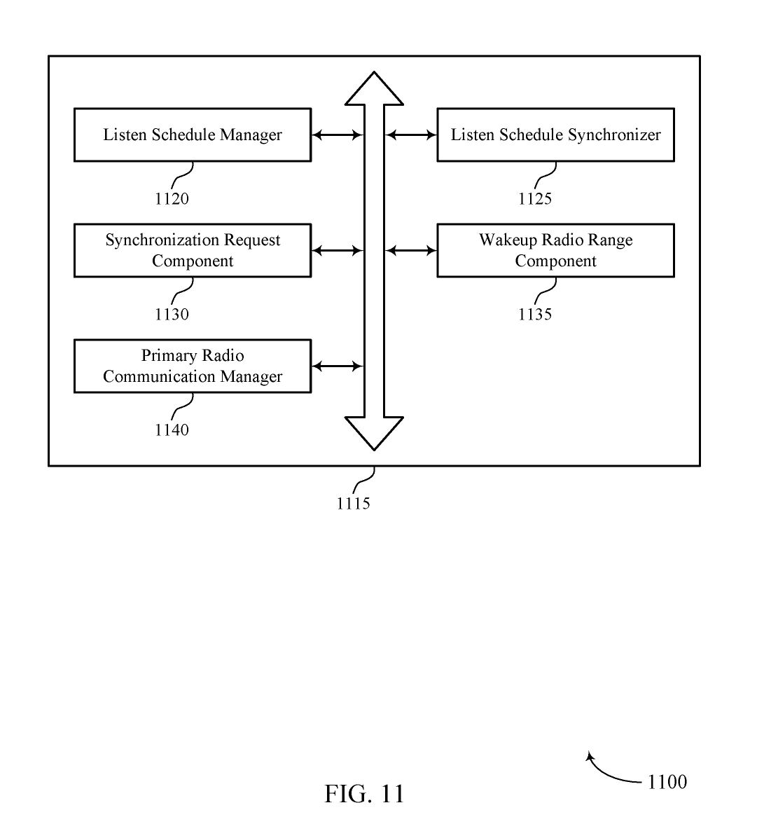

FIG. 11 shows a block diagram 1100 of an AP synchronization manager 1115 that supports wakeup radio synchronization techniques in accordance with various aspects of the present disclosure. The AP synchronization manager 1115 may be an example of aspects of an AP synchronization manager 1215 described with reference to FIGS. 9, 10, and 12. The AP synchronization manager 1115 may include listen schedule manager 1120, listen schedule synchronizer 1125, synchronization request component 1130, wakeup radio range component 1135, and primary radio communication manager 1140. Each of these modules may communicate, directly or indirectly, with one another (e.g., via one or more buses).

Listen schedule manager 1120 may establish a wakeup radio listen schedule for a first wireless device associated with the second wireless device, the wakeup radio listen schedule defining time periods during which a wakeup radio of the first wireless device is powered on to listen for wakeup messages. Listen schedule manager 1120 may identify clock, interval, and offset information for the wakeup radio listen schedule, and identify a target wakeup time interval of the first wireless device.

Listen schedule synchronizer 1125 may transmit, to the first wireless device, the identified clock, interval, and offset information to the first wireless device to synchronize the wakeup radio listen schedule at the first wireless device. In some cases, transmitting the identified clock, interval, and offset information includes transmitting the identified interval and offset information to a primary radio of the first wireless device. In some cases, transmitting the identified clock, interval, and offset information further includes transmitting the identified clock information to a primary radio of the first wireless device in one or more beacon signals or one or more messages dedicated to the transmission of clock information. In some cases, transmitting the identified clock, interval, and offset information further includes transmitting the identified clock information to the wakeup radio of the first wireless device. In some cases, transmitting the identified clock, interval, and offset information further includes transmitting the clock information in a first message to the second wireless device and transmitting the interval information, or the offset information, or a combination thereof, in a second message to the second wireless device. In some cases, transmitting the identified clock, interval, and offset information further includes transmit, to the wakeup radio of the second wireless device, at least a first one of the clock information, the interval information, and the offset information and transmitting, to the primary radio of the second wireless device, at least a second one of the clock information, the interval information, and the offset information. In some cases, the clock information includes at least a portion (e.g., one or more LSBs) of TSF information for the second wireless device.

Synchronization request component 1130 may receive, from the first wireless device, an indication of a synchronization mechanism preference for the first wireless device, where the identified clock, interval, and offset information is transmitted to the first wireless device based on the received indication of the synchronization mechanism preference for the first wireless device. In some cases, the synchronization mechanism preference includes a preference for receiving, using the wakeup radio of the first wireless device, the clock information, or the interval information, or the offset information, or a combination thereof.

Wakeup radio range component 1135 may identify a range of a wakeup radio of the second wireless device to transmit a wakeup message.

Primary radio communication manager 1140 may select a parameter of a primary radio of the second wireless device used to transmit the identified clock, interval, and offset information based on the identified range, the parameter including a MCS, a PPDU format, bandwidth, or a combination thereof.

FIG. 12 shows a diagram of a system 1200 including a device 1205 that supports wakeup radio synchronization techniques in accordance with various aspects of the present disclosure. Device 1205 may be an example of or include the components of AP 105 as described above, e.g., with reference to FIG. 1. Device 1205 may include components for bi-directional voice and data communications including components for transmitting and receiving communications, including AP synchronization manager 1215, processor 1220, memory 1225, software 1230, transceiver 1235, antenna 1240, and I/O controller 1245. These components may be in electronic communication via one or more busses (e.g., bus 1210).

Processor 1220 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1220 may be configured to operate a memory array using a memory controller. In other cases, a memory controller may be integrated into processor 1220. Processor 1220 may be configured to execute computer-readable instructions stored in a memory to perform various functions (e.g., functions or tasks supporting wakeup radio synchronization techniques).

Memory 1225 may include RAM and ROM. The memory 1225 may store computer-readable, computer-executable software 1230 including instructions that, when executed, cause the processor to perform various functions described herein. In some cases, the memory 1225 may contain, among other things, a BIOS which may control basic hardware and/or software operation such as the interaction with peripheral components or devices.

Software 1230 may include code to implement aspects of the present disclosure, including code to support wakeup radio synchronization techniques. Software 1230 may be stored in a non-transitory computer-readable medium such as system memory or other memory. In some cases, the software 1230 may not be directly executable by the processor but may cause a computer (e.g., when compiled and executed) to perform functions described herein.

Transceiver 1235 may communicate bi-directionally, via one or more antennas, wired, or wireless links as described above. For example, the transceiver 1235 may represent a wireless transceiver and may communicate bi-directionally with another wireless transceiver. The transceiver 1235 may also include a modem to modulate the packets and provide the modulated packets to the antennas for transmission, and to demodulate packets received from the antennas.

In some cases, the wireless device may include a single antenna 1240. However, in some cases the device may have more than one antenna 1240, which may be capable of concurrently transmitting or receiving multiple wireless transmissions.

I/O controller 1245 may manage input and output signals for device 1205. I/O controller 1245 may also manage peripherals not integrated into device 1205. In some cases, I/O controller 1245 may represent a physical connection or port to an external peripheral. In some cases, I/O controller 1245 may utilize an operating system such as iOS®, ANDROID®, MS-DOS®, MS-WINDOWS®, OS/2®, UNIX®, LINUX®, or another known operating system. In other cases, I/O controller 1245 may represent or interact with a modem, a keyboard, a mouse, a touchscreen, or a similar device. In some cases, I/O controller 1245 may be implemented as part of a processor. In some cases, a user may interact with device 1205 via I/O controller 1245 or via hardware components controlled by I/O controller 1245.

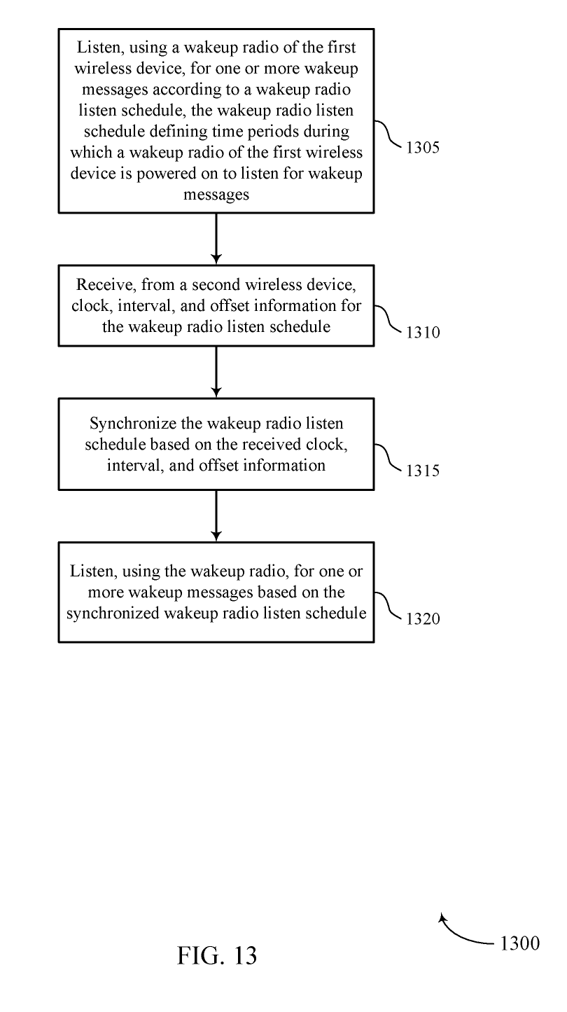

FIG. 13 shows a flowchart illustrating a method 1300 for wakeup radio synchronization techniques in accordance with various aspects of the present disclosure. The operations of method 1300 may be implemented by a STA 115 or its components as described herein. For example, the operations of method 1300 may be performed by a STA synchronization manager as described with reference to FIGS. 5 through 8. In some examples, a STA 115 may execute a set of codes to control the functional elements of the device to perform the functions described below. Additionally or alternatively, the STA 115 may perform aspects of the functions described below using special-purpose hardware.

At block 1305 the STA 115 may listen, using a wakeup radio of the STA 115, for one or more wakeup messages according to a wakeup radio listen schedule, the wakeup radio listen schedule defining time periods during which a wakeup radio of the STA 115 is powered on to listen for wakeup messages. The operations of block 1305 may be performed according to the methods described with reference to FIGS. 1 through 4. In certain examples, aspects of the operations of block 1305 may be performed by a wakeup radio communication manager as described with reference to FIGS. 5 through 8.

At block 1310 the STA 115 may receive, from an AP 105, clock, interval, and offset information for the wakeup radio listen schedule. The operations of block 1310 may be performed according to the methods described with reference to FIGS. 1 through 4. In certain examples, aspects of the operations of block 1310 may be performed by a listen schedule manager as described with reference to FIGS. 5 through 8.

At block 1315 the STA 115 may synchronize the wakeup radio listen schedule based at least in part on the received clock, interval, and offset information. The operations of block 1315 may be performed according to the methods described with reference to FIGS. 1 through 4. In certain examples, aspects of the operations of block 1315 may be performed by a listen schedule synchronizer as described with reference to FIGS. 5 through 8.

At block 1320 the STA 115 may listen, using the wakeup radio, for one or more wakeup messages based at least in part on the synchronized wakeup radio listen schedule. The operations of block 1320 may be performed according to the methods described with reference to FIGS. 1 through 4. In certain examples, aspects of the operations of block 1320 may be performed by a wakeup radio communication manager as described with reference to FIGS. 5 through 8.

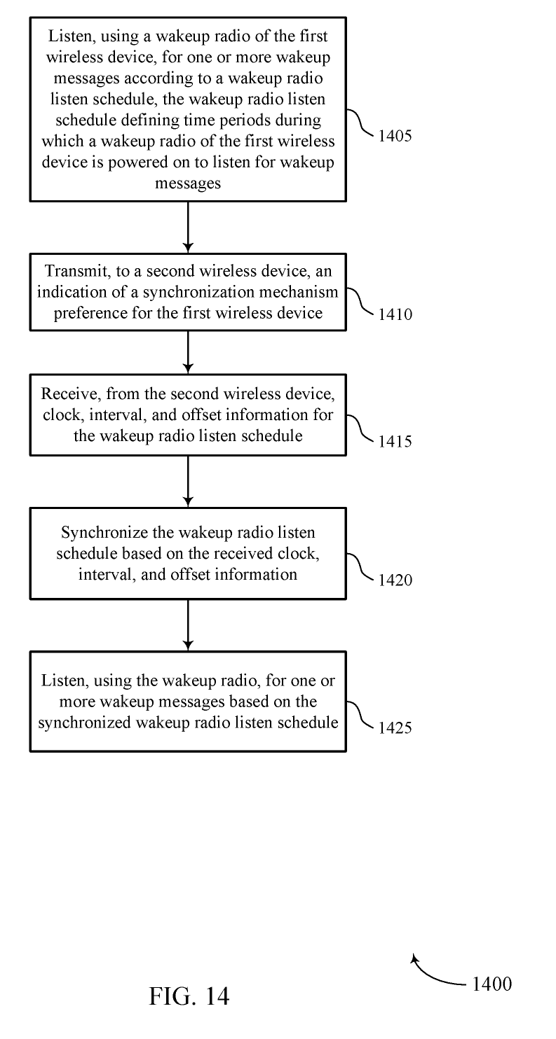

FIG. 14 shows a flowchart illustrating a method 1400 for wakeup radio synchronization techniques in accordance with various aspects of the present disclosure. The operations of method 1400 may be implemented by a STA 115 or its components as described herein. For example, the operations of method 1400 may be performed by a STA synchronization manager as described with reference to FIGS. 5 through 8. In some examples, a STA 115 may execute a set of codes to control the functional elements of the device to perform the functions described below. Additionally or alternatively, the STA 115 may perform aspects of the functions described below using special-purpose hardware.

At block 1405 the STA 115 may listen, using a wakeup radio of the STA 115, for one or more wakeup messages according to a wakeup radio listen schedule, the wakeup radio listen schedule defining time periods during which a wakeup radio of the first wireless device is powered on to listen for wakeup messages. The operations of block 1405 may be performed according to the methods described with reference to FIGS. 1 through 4. In certain examples, aspects of the operations of block 1405 may be performed by a wakeup radio communication manager as described with reference to FIGS. 5 through 8.

At block 1410 the STA 115 may transmit, to an AP 105, an indication of a synchronization mechanism preference for the first wireless device. The operations of block 1410 may be performed according to the methods described with reference to FIGS. 1 through 4. In certain examples, aspects of the operations of block 1410 may be performed by a synchronization request component as described with reference to FIGS. 5 through 8.

At block 1415 the STA 115 may receive, from the AP 105, clock, interval, and offset information for the wakeup radio listen schedule. The operations of block 1415 may be performed according to the methods described with reference to FIGS. 1 through 4. In certain examples, aspects of the operations of block 1415 may be performed by a listen schedule manager as described with reference to FIGS. 5 through 8.

At block 1420 the STA 115 may synchronize the wakeup radio listen schedule based at least in part on the received clock, interval, and offset information. The operations of block 1420 may be performed according to the methods described with reference to FIGS. 1 through 4. In certain examples, aspects of the operations of block 1420 may be performed by a listen schedule synchronizer as described with reference to FIGS. 5 through 8.

At block 1425 the STA 115 may listen, using the wakeup radio, for one or more wakeup messages based at least in part on the synchronized wakeup radio listen schedule.

The operations of block 1425 may be performed according to the methods described with reference to FIGS. 1 through 4. In certain examples, aspects of the operations of block 1425 may be performed by a wakeup radio communication manager as described with reference to FIGS. 5 through 8.

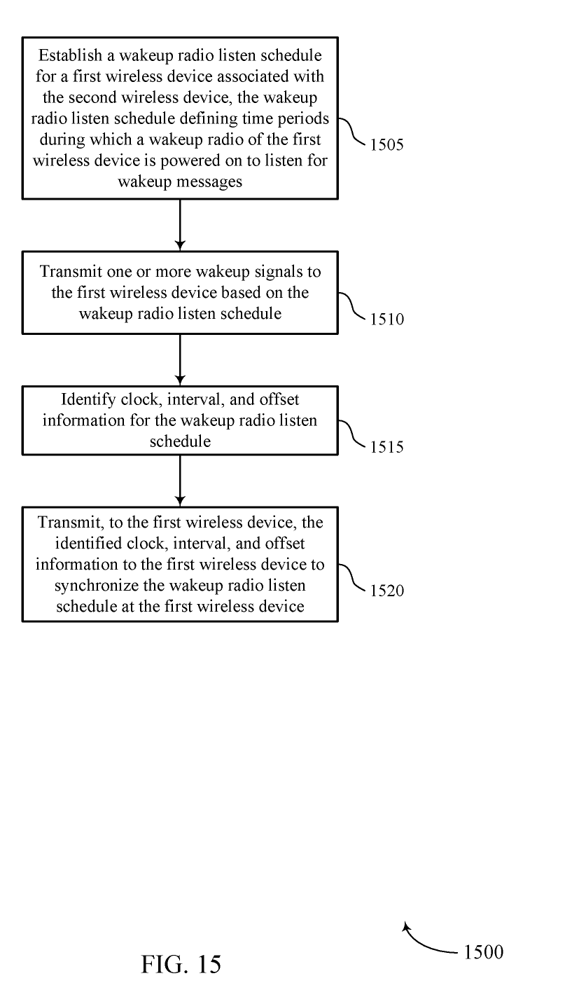

FIG. 15 shows a flowchart illustrating a method 1500 for wakeup radio synchronization techniques in accordance with various aspects of the present disclosure. The operations of method 1500 may be implemented by an AP 105 or its components as described herein. For example, the operations of method 1500 may be performed by an AP synchronization manager as described with reference to FIGS. 9 through 12. In some examples, an AP 105 may execute a set of codes to control the functional elements of the device to perform the functions described below. Additionally or alternatively, the AP 105 may perform aspects of the functions described below using special-purpose hardware.

At block 1505 the AP 105 may establish a wakeup radio listen schedule for a STA 115 associated with the AP 105, the wakeup radio listen schedule defining time periods during which a wakeup radio of the first wireless device is powered on to listen for wakeup messages. The operations of block 1505 may be performed according to the methods described with reference to FIGS. 1 through 4. In certain examples, aspects of the operations of block 1505 may be performed by a listen schedule manager as described with reference to FIGS. 9 through 12.

At block 1510 the AP 105 may transmit one or more wakeup signals to the STA 115 based at least in part on the wakeup radio listen schedule. The operations of block 1510 may be performed according to the methods described with reference to FIGS. 1 through 4. In certain examples, aspects of the operations of block 1510 may be performed by a transmitter as described with reference to FIGS. 9 through 12.

At block 1515 the AP 105 may identify clock, interval, and offset information for the wakeup radio listen schedule. The operations of block 1515 may be performed according to the methods described with reference to FIGS. 1 through 4. In certain examples, aspects of the operations of block 1515 may be performed by a listen schedule manager as described with reference to FIGS. 9 through 12.

At block 1520 the AP 105 may transmit, to the STA 115, the identified clock, interval, and offset information to the STA 115 to synchronize the wakeup radio listen schedule at the STA 115. The operations of block 1520 may be performed according to the methods described with reference to FIGS. 1 through 4. In certain examples, aspects of the operations of block 1520 may be performed by a listen schedule synchronizer as described with reference to FIGS. 9 through 12.

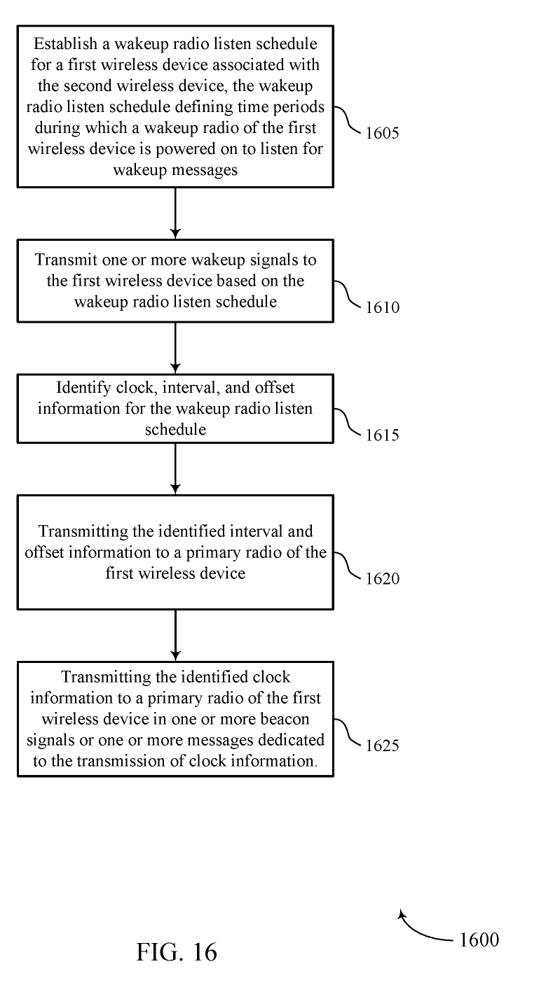

FIG. 16 shows a flowchart illustrating a method 1600 for wakeup radio synchronization techniques in accordance with various aspects of the present disclosure. The operations of method 1600 may be implemented by an AP 105 or its components as described herein. For example, the operations of method 1600 may be performed by an AP synchronization manager as described with reference to FIGS. 9 through 12. In some examples, an AP 105 may execute a set of codes to control the functional elements of the device to perform the functions described below. Additionally or alternatively, the AP 105 may perform aspects of the functions described below using special-purpose hardware.

At block 1605 the AP 105 may establish a wakeup radio listen schedule for a STA 115 associated with the AP 105, the wakeup radio listen schedule defining time periods during which a wakeup radio of the STA 115 is powered on to listen for wakeup messages. The operations of block 1605 may be performed according to the methods described with reference to FIGS. 1 through 4. In certain examples, aspects of the operations of block 1605 may be performed by a listen schedule manager as described with reference to FIGS. 9 through 12.

At block 1610 the AP 105 may transmit one or more wakeup signals to the STA 115 based at least in part on the wakeup radio listen schedule. The operations of block 1610 may be performed according to the methods described with reference to FIGS. 1 through 4. In certain examples, aspects of the operations of block 1610 may be performed by a transmitter as described with reference to FIGS. 9 through 12.

At block 1615 the AP 105 may identify clock, interval, and offset information for the wakeup radio listen schedule. The operations of block 1615 may be performed according to the methods described with reference to FIGS. 1 through 4. In certain examples, aspects of the operations of block 1615 may be performed by a listen schedule manager as described with reference to FIGS. 9 through 12.

At block 1620 the AP 105 may transmit the identified interval and offset information to a primary radio of the STA 115. The operations of block 1620 may be performed according to the methods described with reference to FIGS. 1 through 4. In certain examples, aspects of the operations of block 1620 may be performed by a listen schedule synchronizer as described with reference to FIGS. 9 through 12.

At block 1625 the AP 105 may transmit the identified clock information to a primary radio of the STA 115 in one or more beacon signals or one or more messages dedicated to the transmission of clock information. The operations of block 1625 may be performed according to the methods described with reference to FIGS. 1 through 4. In certain examples, aspects of the operations of block 1625 may be performed by a listen schedule synchronizer as described with reference to FIGS. 9 through 12.

In some cases, transmitting the identified clock, interval, and offset information comprises transmitting the identified interval and offset information to a primary radio of the first wireless device. In some cases, the clock information includes at least a portion (e.g., one or more LSBs) of TSF information.

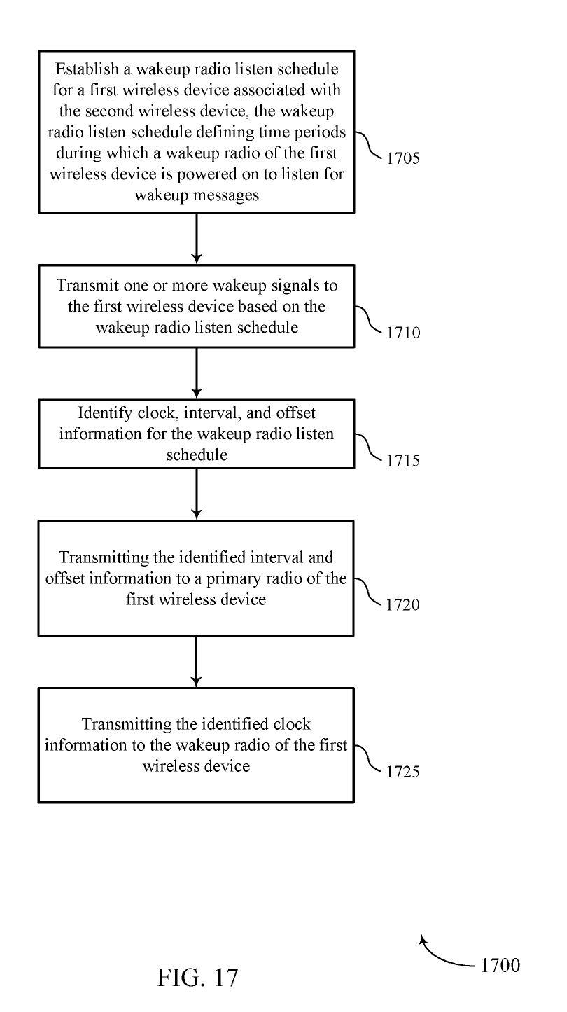

FIG. 17 shows a flowchart illustrating a method 1700 for wakeup radio synchronization techniques in accordance with various aspects of the present disclosure. The operations of method 1700 may be implemented by an AP 105 or its components as described herein. For example, the operations of method 1700 may be performed by an AP synchronization manager as described with reference to FIGS. 9 through 12. In some examples, an AP 105 may execute a set of codes to control the functional elements of the device to perform the functions described below. Additionally or alternatively, the AP 105 may perform aspects of the functions described below using special-purpose hardware.

At block 1705 the AP 105 may establish a wakeup radio listen schedule for a STA 115 associated with the AP 105, the wakeup radio listen schedule defining time periods during which a wakeup radio of the STA 115 is powered on to listen for wakeup messages. The operations of block 1705 may be performed according to the methods described with reference to FIGS. 1 through 4. In certain examples, aspects of the operations of block 1705 may be performed by a listen schedule manager as described with reference to FIGS. 9 through 12.

At block 1710 the AP 105 may transmit one or more wakeup signals to the STA 115 based at least in part on the wakeup radio listen schedule. The operations of block 1710 may be performed according to the methods described with reference to FIGS. 1 through 4. In certain examples, aspects of the operations of block 1710 may be performed by a transmitter as described with reference to FIGS. 9 through 12.

At block 1715 the AP 105 may identify clock, interval, and offset information for the wakeup radio listen schedule. The operations of block 1715 may be performed according to the methods described with reference to FIGS. 1 through 4. In certain examples, aspects of the operations of block 1715 may be performed by a listen schedule manager as described with reference to FIGS. 9 through 12.

At block 1720 the AP 105 may transmit the identified interval and offset information to a primary radio of the STA 115. The operations of block 1720 may be performed according to the methods described with reference to FIGS. 1 through 4. In certain examples, aspects of the operations of block 1720 may be performed by a listen schedule synchronizer as described with reference to FIGS. 9 through 12.

At block 1725 the AP 105 may transmit the identified clock information to the wakeup radio of the STA 115. The operations of block 1725 may be performed according to the methods described with reference to FIGS. 1 through 4. In certain examples, aspects of the operations of block 1725 may be performed by a listen schedule synchronizer as described with reference to FIGS. 9 through 12.

In some cases, transmitting the identified clock, interval, and offset information comprises transmitting the identified interval and offset information to a primary radio of the first wireless device. In some cases, transmitting the identified clock, interval, and offset information further comprises transmitting the identified clock information to the wakeup radio of the first wireless device.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communication systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1× EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communication system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, WLAN 100 and wireless communications system 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for wireless communication at a first wireless device, comprising:
a processor;
memory in electronic communication with the processor; and
instructions stored in the memory and operable, when executed by the processor, to cause the apparatus to:
listen, using a wakeup radio of the first wireless device, for one or more wakeup messages according to a wakeup radio listen schedule, the wakeup radio listen schedule defining time periods during which the wakeup radio of the first wireless device is powered on to listen for wakeup messages;
receive, from a second wireless device, clock, interval, and offset information for the wakeup radio listen schedule;
synchronize the wakeup radio listen schedule based at least in part on the received clock, interval, and offset information; and
listen, using the wakeup radio, for one or more wakeup messages based at least in part on the synchronized wakeup radio listen schedule.

2. The apparatus of claim 1, wherein the instructions are further executable by the processor to:
monitor for the clock, interval, and offset information using a primary radio of the first wireless device.

3. The apparatus of claim 2, wherein the instructions are further executable by the processor to receive the clock, interval, and offset information by being executable by the processor to:
receive, from the second wireless device using the primary radio, the clock information associated with the wakeup radio listen schedule in one or more beacon signals or one or more messages dedicated to transmitting clock information.

4. The apparatus of claim 1, wherein the instructions are further executable by the processor to receive the clock, interval, and offset information by being executable by the processor to:
receive a wakeup signal using the wakeup radio of the first wireless device, the wakeup signal including the clock information, or the interval information, or the offset information, or a combination thereof.

5. The apparatus of claim 4, wherein the instructions are further executable by the processor to:
activate a primary radio of the first wireless device based at least in part on the received wakeup signal; and
communicate with the second wireless device using the primary radio.

6. The apparatus of claim 1, wherein the instructions are further executable by the processor to receive the clock, interval, and offset information by being executable by the processor to:
receive, from the second wireless device and using the wakeup radio of the first wireless device, at least a first one of the clock information, the interval information, and the offset information; and
receive, from the second wireless device and using a primary radio of the first wireless device, at least a second one of the clock information, the interval information, and the offset information.

7. The apparatus of claim 1, wherein the instructions are further executable by the processor to receive the clock, interval, and offset information by being executable by the processor to:
receive the clock information in a first message from the second wireless device; and
receive the interval information, or the offset information, or a combination thereof, in a second message from the second wireless device.

8. The apparatus of claim 1, wherein the instructions are further executable by the processor to:
transmit, to the second wireless device, an indication of a synchronization mechanism preference for the first wireless device.

9. The apparatus of claim 8, wherein the synchronization mechanism preference includes a preference for receiving, using the wakeup radio of the first wireless device, the clock information, or the interval information, or the offset information, or a combination thereof.

10. The apparatus of claim 1, wherein the apparatus is a wireless communication terminal and further comprises an antenna and a transceiver.

11. The apparatus of claim 1, wherein the clock information includes at least a portion of timing synchronization function (TSF) information.

12. The apparatus of claim 11, wherein the portion of TSF information comprises one or more least significant bits (LSBs) of the TSF information for the second wireless device.

13. An apparatus for wireless communication at a first wireless device, comprising:
a processor;
memory in electronic communication with the processor; and
instructions stored in the memory and operable, when executed by the processor, to cause the apparatus to:
establish a wakeup radio listen schedule for a second wireless device associated with the first wireless device, the wakeup radio listen schedule defining time periods during which a wakeup radio of the second wireless device is powered on to listen for wakeup messages;
transmit one or more wakeup signals to the second wireless device based at least in part on the wakeup radio listen schedule;
identify clock, interval, and offset information for the wakeup radio listen schedule; and
transmit the identified clock, interval, and offset information to the second wireless device to synchronize the wakeup radio listen schedule at the second wireless device.

14. The apparatus of claim 13, wherein the instructions are further executable by the processor to:
receive, from the second wireless device, an indication of a synchronization mechanism preference for the second wireless device, wherein the identified clock, interval, and offset information is transmitted to the second wireless device based at least in part on the received indication of the synchronization mechanism preference for the second wireless device.

15. The apparatus of claim 14, wherein the indication of the synchronization mechanism preference for the second wireless device comprises a preference for the first wireless device to transmit the identified clock, interval, and offset information to the wakeup radio of the second wireless device, and the instructions are further executable by the processor to:
transmit the identified clock, interval, and offset information to the wakeup radio of the second wireless device based at least in part on the received synchronization mechanism preference.

16. The apparatus of claim 13, wherein the instructions are further executable by the processor to transmit the identified clock, interval, and offset information by being executable by the processor to:
transmit the identified interval and offset information to a primary radio of the second wireless device.

17. The apparatus of claim 13, wherein the instructions are further executable by the processor to transmit the identified clock, interval, and offset information by being executable by the processor to:
transmit, to the wakeup radio of the second wireless device, at least a first one of the clock information, the interval information, and the offset information; and
transmit, to a primary radio of the second wireless device, at least a second one of the clock information, the interval information, and the offset information.

18. The apparatus of claim 13, wherein the instructions are further executable by the processor to transmit the identified clock, interval, and offset information by being executable by the processor to:
transmit the clock information in a first message to the second wireless device; and
transmit the interval information, or the offset information, or a combination thereof, in a second message to the second wireless device.

19. The apparatus of claim 13, wherein the instructions are further executable by the processor to transmit the identified clock, interval, and offset information by being executable by the processor to:
transmit to the wakeup radio of the second wireless device.

20. The apparatus of claim 13, wherein the instructions are further executable by the processor to:
identify a range of a second wakeup radio of the first wireless device to transmit a wakeup message; and
select a parameter of a primary radio of the first wireless device used to transmit the identified clock, interval, and offset information based at least in part on the identified range, the parameter comprising a modulation and coding scheme (MCS), a physical layer convergence procedure (PLCP) protocol data unit (PPDU) format, bandwidth, or a combination thereof.

21. The apparatus of claim 13, wherein the instructions are further executable by the processor to:
identify a target wakeup time interval of the second wireless device; and
transmit the identified clock, interval, and offset information during the identified target wakeup time interval.

22. The apparatus of claim 13, wherein the clock information includes at least a portion of timing synchronization function (TSF) information.

23. The apparatus of claim 22, wherein the portion of TSF information comprises include one or more least significant bits (LSBs) of the TSF information for the first wireless device.

24. A method for wireless communication at a first wireless device, comprising:
listening, using a wakeup radio of the first wireless device, for one or more wakeup messages according to a wakeup radio listen schedule, the wakeup radio listen schedule defining time periods during which the wakeup radio of the first wireless device is powered on to listen for wakeup messages;
receiving, from a second wireless device, clock, interval, and offset information for the wakeup radio listen schedule;
synchronizing the wakeup radio listen schedule based at least in part on the received clock, interval, and offset information; and
listening, using the wakeup radio, for one or more wakeup messages based at least in part on the synchronized wakeup radio listen schedule.

25. The method of claim 24, further comprising:
monitoring for the clock, interval, and offset information using a primary radio of the first wireless device.

26. The method of claim 25, wherein receiving the clock, interval, and offset information comprises:
receiving, from the second wireless device using the primary radio, the clock information associated with the wakeup radio listen schedule in one or more beacon signals or one or more messages dedicated to transmitting clock information.

27. The method of claim 24, wherein receiving the clock, interval, and offset information comprises:
receiving a wakeup signal using the wakeup radio of the first wireless device, the wakeup signal including the clock information, or the interval information, or the offset information, or a combination thereof.

28. A method for wireless communication at a first wireless device, comprising:
establishing a wakeup radio listen schedule for a second wireless device associated with the first wireless device, the wakeup radio listen schedule defining time periods during which a wakeup radio of the second wireless device is powered on to listen for wakeup messages;
transmitting one or more wakeup signals to the second wireless device based at least in part on the wakeup radio listen schedule;
identifying clock, interval, and offset information for the wakeup radio listen schedule; and
transmitting the identified clock, interval, and offset information to the second wireless device to synchronize the wakeup radio listen schedule at the second wireless device.

29. The method of claim 28, wherein transmitting the identified clock, interval, and offset information comprises:
transmitting the identified interval and offset information to a primary radio of the second wireless device.

30. The method of claim 29, wherein transmitting the identified clock, interval, and offset information further comprises:
transmitting the identified clock information to the primary radio of the second wireless device in one or more beacon signals or one or more messages dedicated to transmitting clock information.
